(19) United States
(12) Patent Application Publication
(10) Pub. No.: US 2018/0211537 A1
(43) Pub. Date: Jul. 26, 2018

(54) METHOD AND DEVICE FOR BRAKING A VEHICLE

(71) Applicant: Robert Bosch GmbH, Stuttgart (DE)

(72) Inventor: Vijay Dhanraj, Stuttgart (DE)

(21) Appl. No.: 15/876,677

(22) Filed: Jan. 22, 2018

(30) Foreign Application Priority Data
Jan. 25, 2017 (DE) 102017201177.7

(51) Int. Cl. G08G 1/16; G05D 1/02; B60W 30/09; B60W 10/18; B60W 10/06; B60W 50/14

(52) U.S. Cl. CPC G08G 1/166; B60W 2710/18; G08G 1/161; G08G 1/164; B60W 30/09; B60W 10/18; B60W 10/06; B60W 50/14; B60T 2201/022; B60T 2210/32; G05D 2201/0213; B60W 2550/408; B60W 2550/20; B60W 2550/14; B60W 2550/12; B60W 2710/0666; G05D 1/0276

(57) ABSTRACT

A method for braking a vehicle, including supplying surroundings data of the vehicle to a braking device; and generating control signals of a brake by using the surroundings data; the surroundings data of the vehicle being provided by a server unit located outside of the vehicle.

### CROSS REFERENCE

The present application claims the benefit under 35 U.S.C. § 119 of German Patent Application No. DE 102017201177.7 filed on Jan. 25, 2017, which is expressly incorporated herein by reference in its entirety.

### FIELD

The present invention relates to a method for braking a vehicle. The present invention furthermore relates to a device for braking a vehicle.

### BACKGROUND INFORMATION

An advanced emergency braking system (AEBS) or autonomous braking system is an autonomous driving safety system, which has sensors in order to detect a distance from a preceding vehicle. For this purpose, a relative speed and a distance between host and target vehicles are detected with respect to an imminent collision. In such a situation, it is possible to use the automatic emergency braking system automatically in order to avoid the collision or at least to mitigate its effects. The United Nations Economic Commission for Europe (UNECE) announced that the mentioned system will be mandatory for new, heavy vehicles beginning in 2015. A recently prepared study determined that by using the mentioned system it is possible to reduce accident numbers by up to 27% and to save up to 8000 human lives per year.

U.S. Pat. No. 6,084,508 describes an automatic emergency braking device of a vehicle including a detection system of the vehicle, which detects obstacles that are situated in or near a travel direction of the vehicle and which produces corresponding data. The emergency braking device furthermore has sensors of the vehicle, which generate data representing characteristic parameters of a state of the vehicle, and an evaluation device, which generates target values from data of the obstacles and from the parameters regarding the state of the vehicle in order to control the movement of the vehicle and which, in the event of an imminent collision of the vehicle that cannot be prevented by a steering or braking action, triggers an automatic emergency braking system for braking the vehicle abruptly.

U.S. Pat. No. 6,523,912 B1 describes an autonomous braking system including an accelerator pedal operated by the driver, which is coupled with a braking system and is used to control a vehicle speed. If a detection device detects an imminent contact, the braking system automatically applies a braking force on the vehicle, while the engine speed is reduced. The degree of the employed braking force is a continuous function of the relative speed, relative distance, collision probability and target classification.

### SUMMARY

It is an object of the present invention to provide an improved braking system for a vehicle.

According to a first aspect of the present invention, the object may be achieved by a method for braking a vehicle, including the steps:
supplying surroundings data of the vehicle to a braking device; and
generating control signals of a brake by using the surroundings data;
the surroundings data of the vehicle being provided by a server device situated outside of the vehicle.

In this manner, the emergency braking system is able to profit from current surroundings data. In this manner, a detection or evaluation of specific traffic situations is advantageously improved so that with the knowledge of these surroundings data the braking system is able to provide an optimized functionality.

According to a second aspect, the object may be achieved by a device for braking a vehicle including:
an engine control unit; and
a brake control unit;
the engine control unit having at least one input, to which a server unit situated outside of the vehicle is able to supply surroundings data of the vehicle, it being possible to generate a control signal for a braking device by using the surroundings data.

Preferred specific embodiments of the method and of the device are described herein.

One advantageous development of the method in accordance with the present invention provides for the surroundings data of the vehicle to be at least one of the following: Data of a road pavement, on which the vehicle is located, a traffic situation, weather data, number of lanes of the roadway on which the vehicle is located, terrain topology of the roadway on which the vehicle is located. In this manner, various surroundings data of the vehicle are provided so that the braking device may be used in a manner that is optimized for the respectively prevailing conditions of the surroundings.

Another advantageous development of the method provides for the surroundings data to be supplied by a server unit situated in a cloud. In this manner, it is possible to provide advantageously a high degree of timeliness of data from a central supraregional server unit.

Another advantageous development of the method is characterized by the fact that the surroundings data are provided by a server unit situated in a local traffic infrastructure device. In this way, an alternative manner of providing the surroundings data of the vehicle is provided, which rather takes into account local/regional aspects.

Another advantageous development of the method is characterized by the fact that the surroundings data of the server unit are provided by vehicles in the surroundings of the vehicle. This supports a high degree of timeliness of the data because data of the server unit are supplied from data of the road users.

The present invention is described below in detail with additional features and advantages with reference to several figures. For this purpose, all described features form the subject matter of the present invention, irrespective of their presentation in the specification and in the figures. The figures are specifically intended to illustrate the main principles of the present invention.

The method features described herein are derived analogously from corresponding described device features and vice versa. This means in particular that features, technical advantages and variants regarding the method for braking a vehicle are analogously derived from corresponding variants, features and advantages regarding a device for braking a vehicle and vice versa.

### BRIEF DESCRIPTION OF THE DRAWINGS

FIG. 1 shows a basic block diagram of a specific embodiment of the provided device.

FIG. 2 shows an overview diagram of a vehicle having the provided device.

FIG. 3 shows a basic sequence of one specific embodiment of the method according to the present invention.

### DETAILED DESCRIPTION OF EXAMPLE EMBODIMENTS

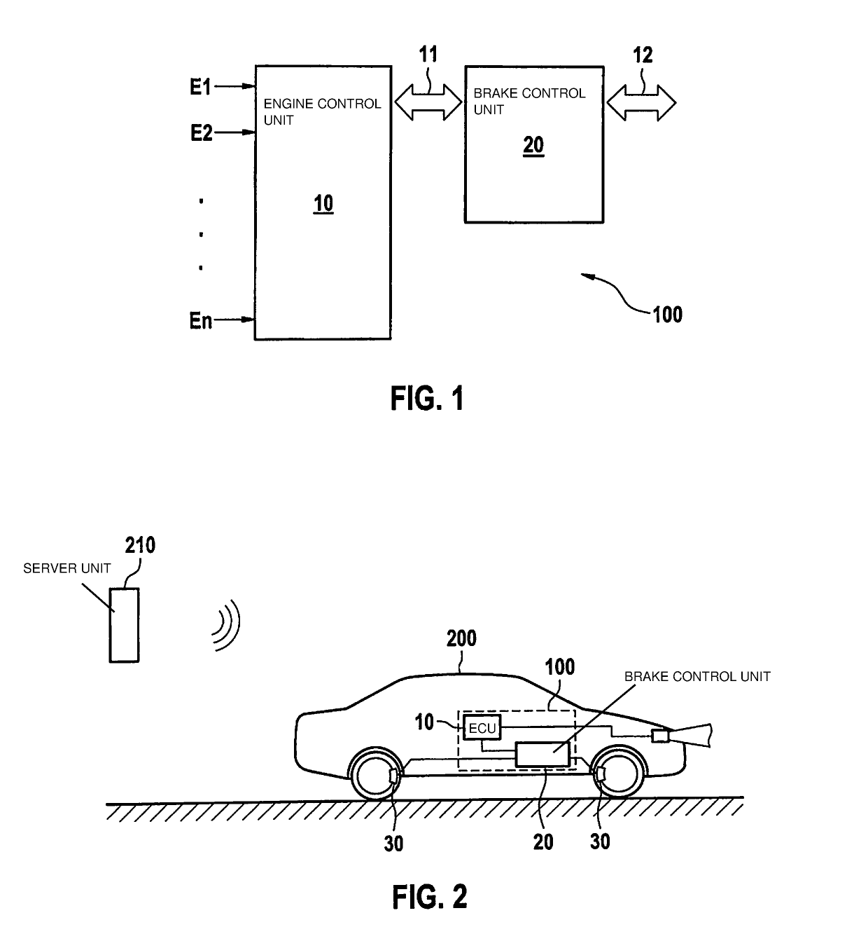

The present invention may provide an improved braking system for a vehicle by providing a greater or improved variety of data for the braking system. FIG. 1 shows a basic block diagram of a device 100 for braking a vehicle. The device has an engine control unit 10 (here an engine control device), which is connected to a brake control unit 20 (here a brake control device) via a bidirectional first bus 11 (e.g., a CAN bus). The brake control unit is connected to at least one mechanical component of a brake device 30 (not shown in FIG. 1) of a vehicle 200 (not shown in FIG. 1) via a bidirectional second bus 12 (e.g., a CAN bus). Engine control unit 10 has multiple inputs E1 . . . En, via which diverse data are supplied to engine control unit 10, for example brake data, data concerning pedals of the vehicle, clutch data, etc.

The present invention provides for engine control unit 10 to be supplied via at least one of inputs E1 . . . En also with data concerning a surroundings of the vehicle or surroundings data of vehicle 200, the surroundings data being provided by a server unit 210 (not shown in FIG. 1), which is situated outside of vehicle 200.

A processing unit of engine control unit 10 and/or of brake control unit 20 computes control signals for the mechanical components of brake device 30 from the surroundings data and transmits these to the mechanical components of brake device 30 via the second bus 12. In this manner, brake device 30 is able to use the mentioned control signals in order to act efficiently in a braking or emergency braking situation of vehicle 200.

FIG. 2 shows a basic representation of a vehicle 200 including the provided device 100. Engine control unit 10 in this instance is functionally connected to brake control unit 20, brake control unit 20 controlling brake devices 30 on front and rear wheels of vehicle 200. The figure shows that surroundings data of a remote server unit 210 are transmitted to vehicle 200 in wireless fashion. It is possible to transmit to vehicle 200 the surroundings data from a server unit 210 that is situated in the cloud. It is also possible to transmit surroundings data to vehicle 200 from a server unit 210 of a traffic infrastructure device (not shown). The mentioned surroundings data are supplied to server unit 210 for example by other road users in the surroundings of vehicle 200 so that in this manner a high degree of timeliness of the surroundings data is supported. For this purpose, it is possible to transmit the data to server unit 210 via a radio-based communication device (e.g., based on GSM, EDGE, UMTS, LTE, WLAN, etc.) of the respective vehicle.

The mentioned surroundings data may include at least one of the following: Data concerning a roadway pavement (asphalt, concrete, non-asphalted, etc.) on which the vehicle is traveling, data concerning a traffic situation (stop-and-go, free-flowing traffic, etc.), data concerning weather (rain, fog, air humidity, sunshine, barometric pressure, etc.), number of lanes of a roadway (single lane, double lane, multiple lanes, etc.) on which vehicle 200 is located or traveling, terrain topology of the roadway (slope, curve radius, curve incline, etc.) on which the vehicle is located or traveling, geometric dimensions (e.g., width of road) of the roadway, on which the vehicle is located or traveling, etc.

Many of the mentioned surroundings data are thus data that are not detectable by a sensor of vehicle 200 or that do not have to be or cannot be detected by sensors of vehicle 200. Advantageously, surroundings data are thereby also provided to vehicle 200, which vehicle 200 does not have to or cannot detect itself, it consequently being possible for vehicle 200 to have fewer sensors.

Vehicle 200 is thus provided with the mentioned surroundings data advantageously in a prompt manner, as a result of which control signals are provided for brake control unit 20, which take into account inter alia the following technical properties of the mechanical components of brake device 30: a minimum time period, which the vehicle requires prior to an automatic braking intervention, dispersion of a braking force of the brake device, a braking force defined per wheel of vehicle 200, etc. Ultimately, in the event of an emergency braking situation, a precise scenario in the surroundings of vehicle 200 is thus known, which makes it possible to perform the braking maneuver of vehicle 200 in a manner that is very precisely adapted to the mentioned surroundings scenario.

For example, a braking maneuver will be performed differently when its raining hard or there is heavy traffic in the surroundings of vehicle 200 than when the roadway is dry, there is little traffic, etc.

The method may preferably be implemented as software, which supports an easy adaptability of the method.

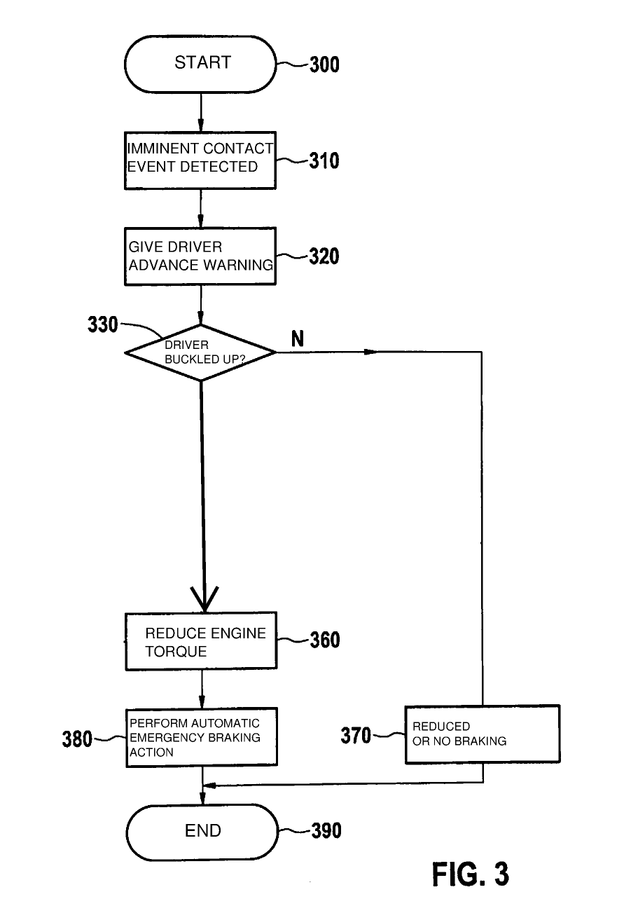

FIG. 3 shows a basic scenario of the provided method.

The method starts in a step 300.

In a step 310, an imminent contact event is detected for vehicle 200.

The driver of vehicle 200 is given advance warning in a step 320.

In a step 330, a check is performed to determine whether the driver is buckled up. If it was determined in step 330 that the driver is not buckled up, a reduced or no braking force is applied on vehicle 200 (step 370).

If it was determined in step 330 that the driver is buckled up, an engine torque of vehicle 200 is reduced in a step 360. An automatic emergency braking action of vehicle 200 is performed in a step 380.

The method is terminated in a step 390.

In the manner described above, it is possible to improve an automatic emergency braking system of a vehicle by using data concerning the roadway, on which vehicle 200 is traveling, and surroundings data, which are received from the cloud-based ADAS system.

Although the present invention was described above with reference to concrete examples of use, one skilled in the art is also able to implement specific embodiments that were not expressly described above or that were described above only partially, without deviating from the present invention.

What is claimed is:

1. A method for braking a vehicle, comprising:
supplying surroundings data of the vehicle to a braking device; and
generating control signals of a brake by using the surroundings data, wherein the surroundings data of the vehicle is provided by a server unit located outside of the vehicle.

2. The method as recited in claim 1, wherein the surroundings data of the vehicle is at least one from among the following: data of a roadway pavement on which the vehicle is situated, a traffic situation, weather data, a number of lanes of a roadway on which vehicle is situated, a terrain topology of the roadway on which the vehicle is situated, geometric dimensions of the roadway on which the vehicle is situated.

3. The method as recited in claim 1, wherein the surroundings data being is provided by the server unit, the server unit being situated in a cloud.

4. The method as recited in claim 1, wherein the surroundings data is provided by the server unit, the server unit being situated in a local traffic infrastructure device.

5. The method as recited in claim 1, wherein the surroundings data of the server unit is provided by vehicles in the surroundings of the vehicle.

6. A device for braking a vehicle, comprising:
an engine control unit; and
a brake control unit;
wherein the engine control unit has at least one input to which surroundings data of the vehicle are able to bee supplied by a server unit situated outside of the vehicle, a control signal for a brake device being able to be generated by using the surroundings data.

7. The device as recited in claim 6, wherein the surroundings data is providable from a server unit situated in a cloud.

8. The device as recited in claim 6, wherein the surroundings data is providable from a server unit situated in a traffic infrastructure device.

9. A non-transitory computer-readable data carrier on which is stored a computer program having program code for braking a vehicle, the computer program, when executed by a device of the vehicle, causing the device to perform:
supplying surroundings data of the vehicle to a braking device; and
generating control signals of a brake by using the surroundings data, wherein the surroundings data of the vehicle is provided by a server unit located outside of the vehicle.
